(19) United States
(12) Patent Application Publication
(10) Pub. No.: US 2018/0035046 A1
(43) Pub. Date: Feb. 1, 2018

(54) BLOCK-BASED LENSLESS COMPRESSIVE IMAGE ACQUISITION

(71) Applicants: Xin Yuan, Summit, NJ (US); Gang Huang, Monroe Township, NJ (US); Hong Jiang, Warren, NJ (US); Paul A. Wilford, Bernardsville, NJ (US)

(72) Inventors: Xin Yuan, Summit, NJ (US); Gang Huang, Monroe Township, NJ (US); Hong Jiang, Warren, NJ (US); Paul A. Wilford, Bernardsville, NJ (US)

(21) Appl. No.: 15/223,204

(22) Filed: Jul. 29, 2016

(51) Int. Cl. H04N 5/232; G02B 27/58; H04N 5/225

(52) U.S. Cl. CPC H04N 5/23238; H04N 5/2258; H04N 5/2253; H04N 5/2254; G02B 27/58

(57) ABSTRACT

The present disclosure generally discloses block-based lensless compressive image acquisition capabilities. The block-based lensless compressive image acquisition capabilities may include a block-based lensless camera. The block-based lensless camera may include a set of two or more image acquisition block configured to capture respective sets of image data (e.g., detector outputs or compressive measurements produced from detector outputs) for respective image portions of an image to be captured by the block-based lensless camera. The blocks of a block-based lensless camera may each include an aperture including a set of aperture elements, a sensor, and an isolation chamber disposed between the aperture and the sensor for directing light from the aperture to the sensor while preventing comingling of light of the block and light of other blocks.

### TECHNICAL FIELD

The present disclosure relates generally to image acquisition and, more particularly but not exclusively, to lensless compressive image acquisition.

### BACKGROUND

Image acquisition, as performed by contemporary digital image or video systems, generally involves the acquisition and immediate compression of large amounts of raw image or video data. This typically requires use of large numbers of sensors as well as significant computational capabilities.

### SUMMARY

The present disclosure generally discloses block-based lensless compressive image acquisition.

In at least some embodiments, a lensless compressive camera includes at least two image acquisition blocks. The image acquisition blocks each include an aperture including a set of aperture elements wherein each of the aperture elements is configured to be controlled to permit or prevent passage of light therethrough, a sensor configured to detect light passing through the aperture, and an isolation chamber disposed between the aperture and the sensor wherein the isolation chamber is configured to isolate the light passing through the aperture to be incident on the sensor and to prevent comingling of the light passing through the aperture with light of other image acquisition blocks.

In at least some embodiments, a lensless compressive image acquisition device includes a lensless compressive camera, a memory, and a processor. The lensless compressive camera includes at least two image acquisition blocks. The image acquisition blocks each include an aperture including a set of aperture elements wherein each of the aperture elements is configured to be controlled to permit or prevent passage of light therethrough, a sensor configured to detect light passing through the aperture, and an isolation chamber disposed between the aperture and the sensor wherein the isolation chamber is configured to isolate the light passing through the aperture to be incident on the sensor and to prevent comingling of the light passing through the aperture with light of other image acquisition blocks. The memory is configured to store respective sets of compressive measurements associated with the respective image acquisition blocks. The processor is configured to reconstruct an image based on processing of the respective sets of compressive measurements of the respective image acquisition blocks.

In at least some embodiments, a lensless compressive camera includes an aperture assembly, a sensor assembly, and an isolation assembly. The aperture assembly includes a set of apertures, each of the apertures including a respective set of aperture elements configured to be controlled to permit or prevent passage of light therethrough. The sensor assembly includes a set of sensors, each of the sensors configured to detect light incident thereon. The isolation assembly is disposed between the aperture assembly and the sensor assembly. The isolation assembly includes a set of isolation chambers configured to isolate light passing through respective apertures of the aperture assembly to be incident on respective sensors of the sensor assembly and configured to prevent comingling of light between the isolation chambers.

### BRIEF DESCRIPTION OF THE DRAWINGS

The teachings herein can be readily understood by considering the following detailed description in conjunction with the accompanying drawings, in which:

FIG. 1 depicts an exemplary block-based lensless compressive image acquisition system;

FIG. 2 depicts an exemplary block-based lensless camera for use in the block-based lensless compressive image acquisition system of FIG. 1;

FIG. 3 depicts an exemplary aperture assembly including apertures and associated sensors for illustrating measurement basis information and compressive measurements for a block-based lensless camera;

FIGS. 4A-4C depict exemplary cross-sectional views of aperture assemblies and sensor assemblies for a block-based lensless camera;

FIGS. 5A-5C depict an exemplary concentration-sensor configuration of a block-based lensless camera using cellular-shaped apertures and cellular-shaped sensors;

FIG. 6 depicts an exemplary block-based lensless compressive image acquisition system including an image reconstruction process for reconstructing an image captured by a block-based lensless camera;

FIG. 7 depicts an exemplary embodiment of an image reconstruction process; and

FIG. 8 depicts a high-level block diagram of a computer suitable for use in performing various functions described herein.

To facilitate understanding, identical reference numerals have been used, where possible, to designate identical elements that are common to the figures.

### DETAILED DESCRIPTION

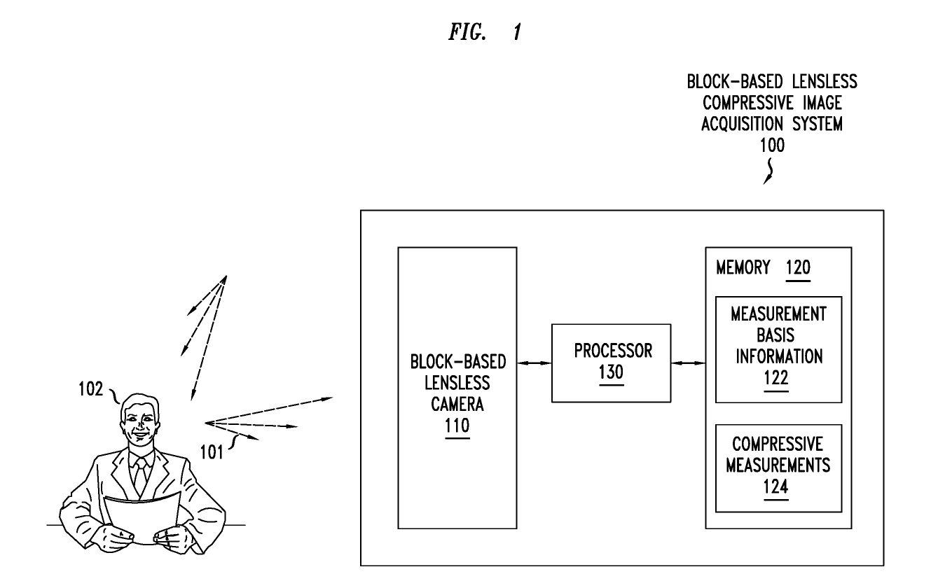

The present disclosure generally discloses block-based lensless compressive image acquisition capabilities. The block-based lensless compressive image acquisition capabilities may include a block-based lensless camera. The block-based lensless camera may include a set of two or more image acquisition blocks (which also may be referred to more generally herein as blocks) configured to capture respective sets of image data (e.g., detector outputs or compressive measurements produced from detector outputs) for respective image portions of an image to be captured by the block-based lensless camera. The blocks of a block-based lensless camera may each include an aperture including a set of aperture elements, a sensor, and an isolation chamber disposed between the aperture and the sensor and configured to isolate the light passing through the aperture to be incident on the sensor and to prevent comingling of the light passing through the aperture with light of other blocks. The block-based lensless camera may include an aperture assembly, a sensor assembly, and an isolation assembly, where the isolation assembly may be disposed between the aperture assembly and the sensor assembly and where the isolation assembly may include a set of isolation chambers configured to isolate respective portions of the aperture assembly and respective portions of the sensor assembly to provide thereby the respective blocks. The aperture assembly may include a set of apertures and the sensor assembly may include a set of sensors, such that the respective isolation chambers of the isolation assembly isolate respective apertures of the aperture assembly and respective subsets of sensors of the sensor assembly to provide thereby the respective blocks. The aperture assembly, the sensor assembly, and the isolation assembly may be configured such that, for each of the respective blocks, the respective isolation chamber ensures that light passing through the respective aperture for the respective block is incident only on the sensor of the respective block and is not comingled with light from other blocks. These and various other embodiments and advantages of block-based lensless compressive image acquisition capabilities may be further understood by way of reference to the exemplary lensless compressive image acquisition system of FIG. 1.

FIG. 1 depicts an exemplary block-based lensless compressive image acquisition system.

As depicted in FIG. 1, incident light 101 reflecting from an object 102 is received by a block-based lensless compressive image acquisition system 100 that is configured to perform block-based compressive image acquisition to capture an image depicting the object 102.

The block-based lensless compressive image acquisition system 100 includes a block-based lensless camera 110, a memory 120, and a processor 130. The processor 130 is communicatively connected to the block-based lensless camera 110 and the memory 120.

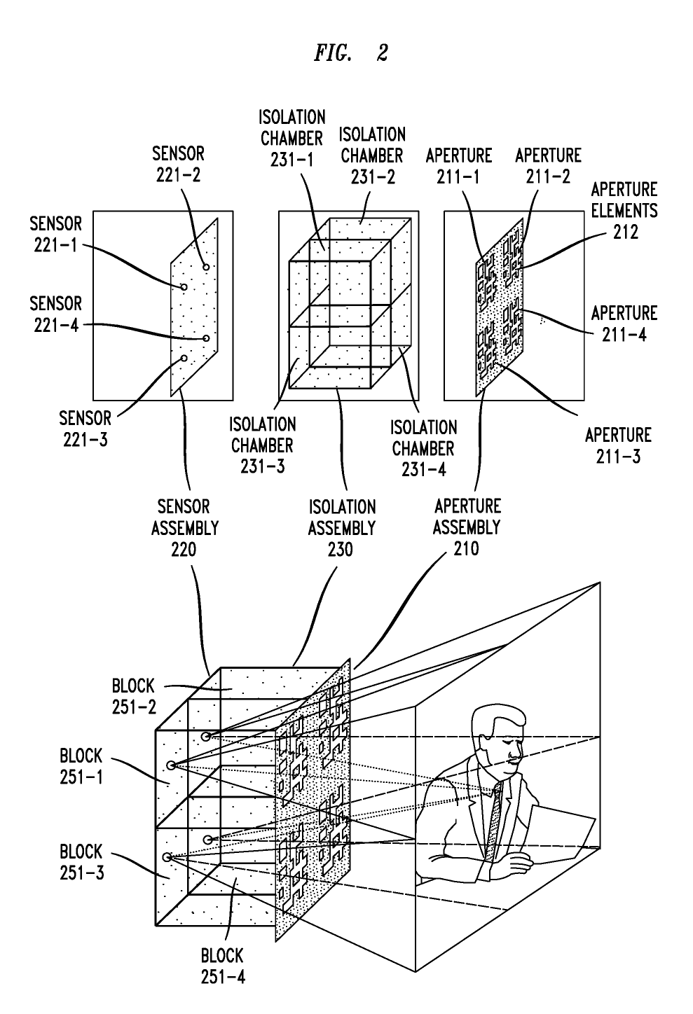

The block-based lensless camera 110 is configured to perform block-based compressive sampling for compressive image acquisition. An exemplary block-based lensless camera 110 is depicted and described with respect to FIG. 2. It will be appreciated that, although primarily presented with respect to embodiments in which block-based lensless camera 110 produces compressive measurements for compressive image acquisition, in at least some embodiments the compressive measurements for compressive image acquisition may be produced by an element other than block-based lensless camera 110 (e.g., processor 130 or a remote element) based on detector output data produced by block-based lensless camera 110 (e.g., detector output data produced by detectors of block-based lensless camera 110).

The memory 120 is configured to store information associated with block-based lensless compressive image acquisition. The memory 120 is configured to store measurement basis information 122 for use by the block-based lensless camera 110 in performing block-based compressive sampling. The memory 120 is configured to store compressive measurements 124 that are produced by block-based lensless camera 110 while performing block-based compressive sampling.

The processor 130 is configured to control the operation of block-based lensless camera 110 to perform block-based compressive sampling for compressive image acquisition. The processor 130 may be configured to use the measurement basis information 122 to control or facilitate block-based compressive sampling by the block-based lensless camera 110. The processor 130 may be configured to receive the compressive measurements 124 produced by the block-based lensless camera 110 while performing block-based compressive sampling and to control storage of the compressive measurements 124 produced by the block-based lensless camera 110 in the memory 120. The processor 130 also may be configured to provide additional processing functions related to block-based lensless compressive image acquisition by block-based lensless camera 110, such as performing image reconstruction processing in order to reconstruct the image captured by block-based lensless camera 110, providing handling of the image captured by block-based lensless camera 110 (e.g., storage, display, transmission, or the like), or the like.

It will be appreciated that block-based lensless compressive image acquisition system 100 may be provided within various contexts. For example, block-based lensless compressive image acquisition system 100 may form part of a tablet, a smartphone, an Internet-of-Things (IoT) device, or the like.

It will be appreciated that, although primarily presented with respect to an embodiment in which the functions of the block-based lensless camera 110, the memory 120, and the processor 130 are integrated into a single device or system (illustratively, block-based lensless compressive image acquisition system 100), various functions of the block-based lensless camera 110, the memory 120, and the processor 130 may be separated into multiple devices or systems which may be centralized or distributed (e.g., physically, geographically, or the like, as well as various combinations thereof).

FIG. 2 depicts an exemplary block-based lensless camera for use in the block-based lensless compressive image acquisition system of FIG. 1.

The block-based lensless camera 200 includes an aperture assembly 210, a sensor assembly 220, and an isolation assembly 230. The isolation assembly 230 is arranged between the aperture assembly 210 and the sensor assembly 220.

The block-based lensless camera 200, as discussed further below, is arranged into four equal-sized image acquisition blocks 251 which are referred to more generally as blocks 251 (although it will be appreciated that fewer or more blocks 251 may be used, blocks 251 may have different block sizes (e.g., in terms of the number of aperture elements per aperture, the number of pixels supported, physical size, or the like, as well as various combinations thereof), or the like, as well as various combinations thereof).

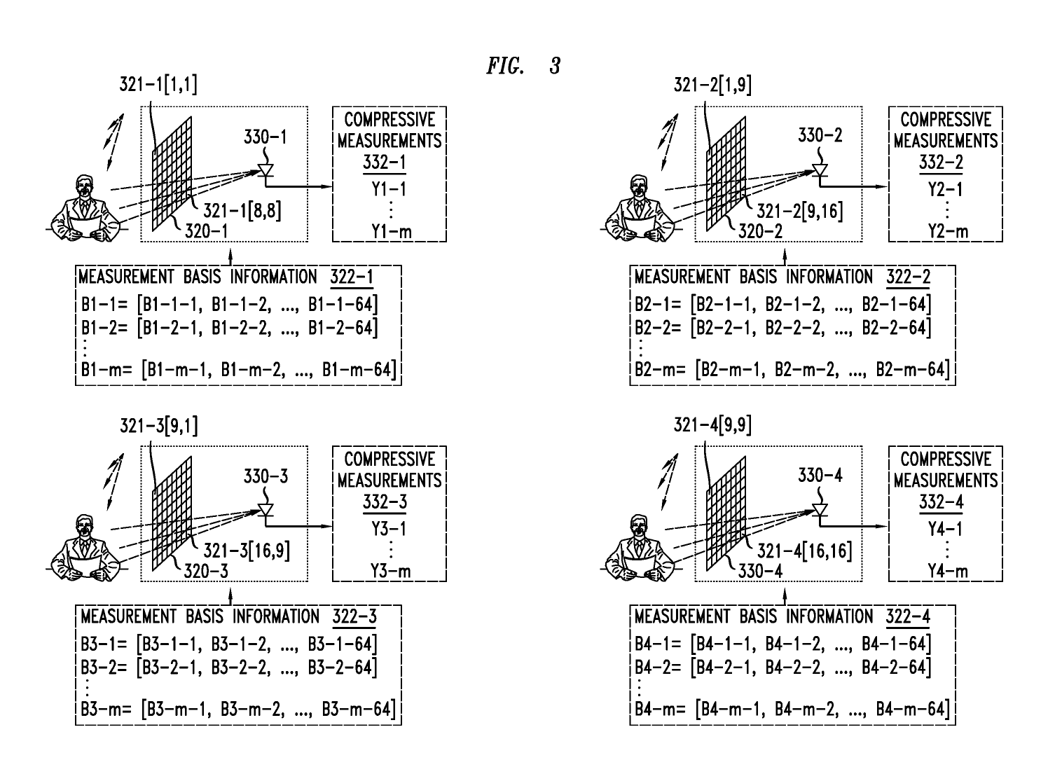

The aperture assembly 210 includes a set of apertures 211. The aperture assembly 210 includes four apertures 211 (illustratively, apertures 211-1, 211-2, 211-3, and 211-4) which correspond to the four blocks 251 of the block-based lensless camera 200. The apertures 211 each include an array of aperture elements 212 (which also may be referred to herein as programmable aperture elements or programmable elements), respectively. The apertures 211 of aperture assembly 210 are each arranged as a two-dimensional array (8×8) of aperture elements 212 (where the notation [x,y] may be used to denote the aperture element 212 at row x/column y of the respective array of aperture elements 212 of the respective aperture 211), respectively. The aperture elements 212 of aperture assembly 210 are configured to be individually controlled to permit light to pass therethrough or to prevent light from passing therethrough. The transmittance of each of the aperture elements 212 can be programmable to be a specific value. The transmittance of each of the aperture elements 212 can be programmable to be a specific value using measurement basis information. For example, the measurement basis information may be in the form of a matrix (or other suitable data structure) having a set of entries corresponding to the aperture elements 212 of the programmable aperture 210, respectively. The transmittance values for the aperture elements 212 may be binary values, such as where each entry may have a value of 0 (e.g., no transmittance of light through the respective aperture element 212) or a value of 1 (e.g., full transmittance of light through the respective aperture element 212). The transmittance values for the aperture elements 212 may support a range of values (e.g., between 0 and 1, or between any other suitable range of values), such that the transmittance value of a given aperture element 212 is indicative of the amount of transmittance of the aperture element 212 (e.g., intermediate values give some, but not full, transmittance of light). It will be appreciated that other values may be used to control the aperture elements 212 of the apertures 211 of the aperture assembly 210. The aperture elements 212 of the apertures 211 of the aperture assembly 210 may be controlled electrically (e.g., under the control of a processor or other control element), mechanically (e.g., using a digital micromirror device (DMD) or other suitable device), or the like, as well as various combinations thereof. For example, the aperture elements 212 may be a transparent liquid crystal display (LCD) device having programmable LCD elements, a transparent liquid crystal on silicon (LCoS) device having programmable LCoS elements, or the like. The aperture elements 212 are controlled using measurement basis information, as presented in additional detail with respect to FIG. 3. It will be appreciated that, although the aperture assembly 210 is primarily presented as being composed of apertures 211 having respective sets of aperture elements 212, in at least some embodiments the aperture elements 212 themselves may be considered to be apertures (e.g., the aperture assembly 210 may be considered to be an a two-dimensional array (64×64) of apertures such that it includes two-hundred and fifty-six apertures (e.g., which may be denoted as [1,1]-[16,16]) which may be considered to be logically divided into four subsets of apertures (e.g., four two-dimensional arrays (8×8) of apertures, such that each subset of apertures includes sixty-four apertures out of the two-hundred and fifty-six apertures, respectively).

The sensor assembly 220 includes a set of sensors 221-1-221-4 (collectively, sensors 221). The four sensors 221-1-221-4 of the set of sensors 221 correspond to the four blocks 251 of the block-based lensless camera 200, respectively. The sensors 221 are each configured to detect light incident thereon (passing through aperture elements 212 of respective apertures 211 of aperture assembly 210) and to generate compressive measurements based on detection of the light incident thereon. More specifically, the first sensor 221-1 is arranged to detect light passing through aperture elements 212 of the first aperture 211-1, the second sensor 221-2 is arranged to detect light passing through aperture elements 212 of the second aperture 211-2, the third sensor 221-3 is arranged to detect light passing through aperture elements 212 of the third apertures 211-3, and the fourth sensor 221-4 is arranged to detect light passing through aperture elements 212 of the fourth aperture 211-4. The light passing through aperture elements 212 of apertures 211 is made incident on the sensors 221, respectively, using the isolation assembly 230 (which prevents comingling of light between blocks 251 of the block-based lensless camera 200), which is discussed further below. The sensors 221 may each include (1) a detector that is configured to detect light and to produce a detector output based on the detected light and (2) a compressive measurement device configured to produce a compressive measurement based on the detector output of the detector. For example, the detector may be a photon detector (or other suitable device) and the compressive measurement device may be an analog-to-digital (A/D) converter (or other suitable device) configured to produce discretized compressive measurements based on the detector output. It will be appreciated that, although primarily presented with respect to embodiments in which the sensors 221 produce compressive measurements for compressive image acquisition, in at least some embodiments the compressive measurements for compressive image acquisition may be produced by an element other than sensors 221 (e.g., a processor or other device or element which receives the detector outputs from the sensors 221 where the sensors 221 include photon detectors but do not include compressive measurement devices such as A/D converters).

The isolation assembly 230 includes a set of isolation chambers 231-1-231-4 (collectively, isolation chambers 231). The four isolation chambers 231-1-231-4 correspond to the four blocks 251 of the block-based lensless camera 200, respectively. The isolation chambers 231 are each configured to keep light passing through the isolation chambers contained therein, thereby preventing comingling of light between the isolation chambers 231. More specifically, the first isolation chamber 231-1 is configured to contain light passing through aperture elements 212 of aperture 211-1 for detection by the first sensor 221-1, the second isolation chamber 231-2 is configured to contain light passing through aperture elements 212 of the second aperture 211-2 for detection by the second sensor 221-2, the third isolation chamber 231-3 is configured to contain light passing through aperture elements 212 of the third aperture 211-3 for detection by the third sensor 221-3, and the fourth isolation chamber 231-4 is configured to contain light passing through aperture elements 212 of the fourth aperture 211-4 for detection by the fourth sensor 221-4. The isolation assembly 230 may be configured in various ways (e.g., isolation assembly 230 may be composed of a housing configured to house the isolation chambers 231, the isolation assembly may be composed of a housing which may be divided to provide the isolation chambers 231, or the like).

The blocks 251 of the block-based lensless camera 200, as indicated above, each include a respective combination of an aperture 211-x (including a respective set of aperture elements 212-x), a sensor 221-x, and an isolation chamber 231-x. As depicted in FIG. 2, a first block 251 includes aperture elements 212 of a first aperture 211-1, a first sensor 221-1, and a first isolation chamber 231-1, which are arranged such that light passing through open aperture elements 212 of the first aperture 211-1 also passes through the first isolation chamber 231-1 such that it is detected only by the first sensor 231-1 (and not detected by any of the other sensors 231-2, 231-3, and 231-4). Similarly, as depicted in FIG. 2, a second block 251-2 includes aperture elements 212 of a second aperture 211-2, a second sensor 221-2, and a second isolation chamber 231-2, which are arranged such that light passing through open aperture elements 212 of the second aperture 211-2 also passes through the second isolation chamber 231-2 such that it is detected only by the second sensor 231-2 (and not detected by any of the other sensors 231-1, 231-3, and 231-4). Similarly, as depicted in FIG. 2, a third block 251-3 includes aperture elements 212 of a third aperture 211-3, a third sensor 221-3, and a third isolation chamber 231-3, which are arranged such that light passing through open aperture elements 212 of the third aperture 211-3 also passes through the third isolation chamber 231-3 such that it is detected only by the third sensor 231-3 (and not detected by any of the other sensors 231-1, 231-2, and 231-4). Similarly, as depicted in FIG. 2, a fourth block 251-4 includes aperture elements 212 of a fourth aperture 211-4, a fourth sensor 221-4, and a fourth isolation chamber 231-4, which are arranged such that light passing through open aperture elements 212 of the fourth aperture 211-4 also passes through the fourth isolation chamber 231-4 such that it is detected only by the fourth sensor 231-4 (and not detected by any of the other sensors 231-1, 231-2, and 231-3).

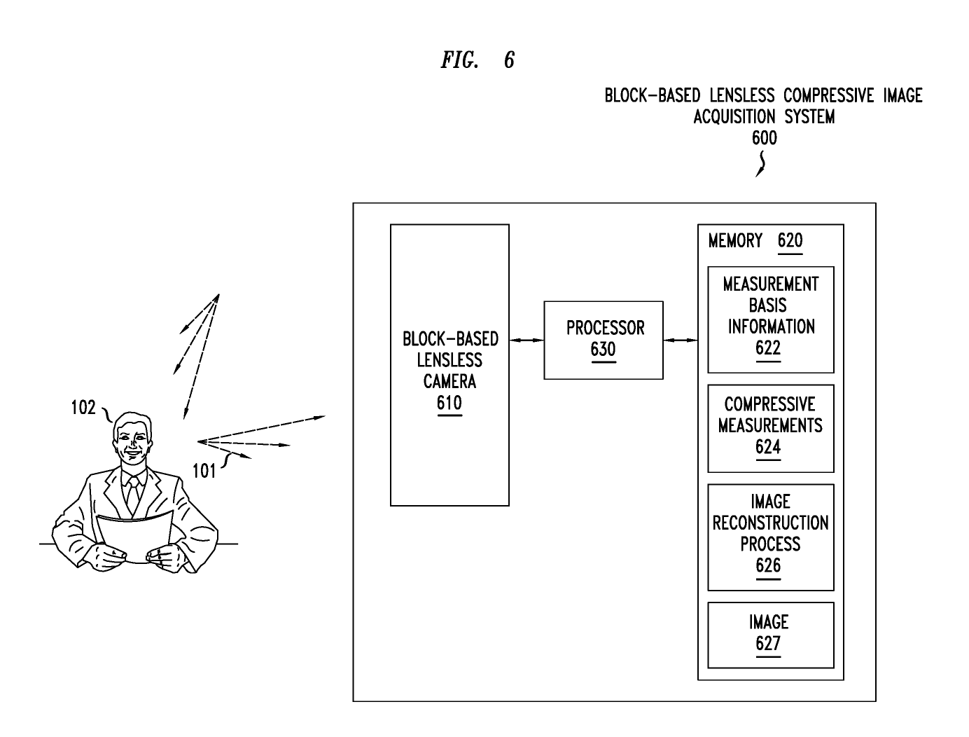

The blocks 251 of the block-based lensless camera 200, as illustrated in FIG. 2, each capture a respective portion of the image to be captured by the block-based lensless camera 200 (denoted as image portions). The image portions captured by the blocks 251 are overlapping, such that the image to be captured by the block-based lensless camera 200 may be reconstructed by stitching together the image portions captured by the blocks 251 of the block-based lensless camera 200, respectively. The reconstruction of the image portions and associated reconstruction of the image from the image portions may be further understood by way of reference to FIG. 6.

It will be appreciated that, although primarily presented with respect to embodiments in which a single aperture assembly (illustratively, aperture assembly 210) is logically divided and operated (illustratively, as multiple apertures 211 each composed of aperture elements 212) to provide the multiple blocks 251 of the block-based lensless camera 200, in at least some embodiments multiple aperture assemblies may be used to provide the multiple blocks 251 of the block-based lensless camera 200. For example, two aperture assemblies may be used, where either or both of the two aperture assemblies may be logically divided and operated to provide the multiple blocks 251 of the block-based lensless camera 200. For example, separate aperture assemblies may be used to provide each of the blocks 251 of the block-based lensless camera 200. It will be appreciated that various other numbers of aperture assemblies may be used to support various numbers of blocks of a block-based lensless camera.

It will be appreciated that, although primarily presented with respect to embodiments in which a single sensor assembly (illustratively, sensor assembly 220) includes the multiple sensors (illustratively, sensors 221) to provide the multiple blocks 251 of the block-based lensless camera 200, in at least some embodiments multiple sensor assemblies may be used to provide the multiple blocks 251 of the block-based lensless camera 200. For example, two sensor assemblies may be used, where each of the two sensor assemblies may include one or more sensors, to provide the multiple blocks 251 of the block-based lensless camera 200. For example, separate sensor assemblies may be used to provide each of the blocks 251 of the block-based lensless camera 200. It will be appreciated that various other numbers of sensor assemblies may be used to support various numbers of blocks of a block-based lensless camera.

It will be appreciated that, although primarily presented with respect to embodiments in which a single isolation assembly (illustratively, isolation assembly 230) includes the multiple isolation chambers (illustratively, isolation chambers 231) to provide the multiple blocks 251 of the block-based lensless camera 200, in at least some embodiments multiple isolation assemblies may be used to provide the multiple blocks 251 of the block-based lensless camera 200. For example, two isolation assemblies may be used, where each of the two isolation assemblies may include one or more isolation chambers, to provide the multiple blocks 251 of the block-based lensless camera 200. For example, separate isolation assemblies may be used to provide each of the blocks 251 of the block-based lensless camera 200. It will be appreciated that various other numbers of isolation assemblies may be used to support various numbers of blocks of a block-based lensless camera.

It will be appreciated that, although primarily presented with respect to embodiments in which block-based lensless camera 200 includes a specific arrangement of blocks 251 (e.g., including four blocks 251 which are each of the same size, arranged in a particular pattern, and so forth), in at least some embodiments the block-based lensless camera 200 may include various other arrangements of blocks 251 (e.g., using fewer or more blocks, using blocks having different block sizes, using different arrangements of the blocks with respect to each other, or the like, as well as various combinations thereof).

FIG. 3 depicts exemplary blocks of a block-based lensless camera for illustrating measurement basis information and compressive measurements for the block-based lensless camera.

The block-based lensless camera 300 includes four blocks 310-1-310-4 (collectively, blocks 310). The blocks 310-1-310-4 include apertures 320-1-320-4 (collectively, apertures 320), respectively. The blocks 310-1-310-4 also include sensors 330-1-330-4 (collectively, sensors 330), respectively. It is noted that the isolation chambers for the blocks 310 have been omitted from FIG. 3 for purposes of clarity.

The apertures 320-1-320-4 each include aperture elements 321, respectively. As depicted in FIG. 3, each of the apertures 320 includes an 8×8 array of aperture elements 321, respectively (although, as indicated above, each of apertures 320 may include fewer or more aperture elements 321). The closing (to prevent light from passing therethrough) and opening (to permit light to pass therethrough) of the respective aperture elements 321 of the apertures 320-1-320-4 is controlled based on measurement basis information 322-1-322-4 (collectively, measurement basis information 322) that is associated with the apertures 320-1-320-4, respectively.

In general, the measurement basis information 322-x for a given aperture 320-x includes, where m compressive measurements are to be made based on detection of light passing through aperture elements 321 of the given aperture 320-x, m arrays of measurement basis values (denoted using the notation Bx-y), where each array of measurement basis values includes a respective bit value corresponding to each of the respective aperture elements 321 of the given aperture 320-x (denoted using the notation Bx-y-z). For example, the measurement basis information 322-1 for aperture 320-1 includes m arrays of measurement basis values (denoted as B1-1, B1-2, . . . , B1-m), where measurement basis value array B1-1 includes 64 values (denoted as B1-1-1 through B1-1-64), measurement basis value array B1-2 includes 64 values (denoted as B1-2-1 through B1-2-64), and so forth, through measurement basis value array B1-m. It will be appreciated that, for a given aperture 320, at least some of the measurement basis value arrays Bx-y of the given aperture 320 may be different (i.e., the sets of bit values of the measurement basis value arrays Bx-y for the given aperture 320-x may be different) so as to make different quantities and patterns of light incident on the associated sensor 330-x of the given aperture 320-x during the m compressive measurements associated with the given aperture 320-x.

In general, the bit value of a measurement basis value array Bx-y that corresponds to a particular aperture element 321 of an aperture 320, for a given compressive measurement to be made based on acquisition of light by a corresponding sensor 330 associated with the aperture 320, may be set to a value indicative of the transmittance of the aperture element 321 (e.g., a value of “0” to indicate that there is to be no transmittance of light through the aperture element 321 or a value of “1” to indicate that there is to be a full transmittance of light through the aperture element 321). In FIG. 3, for purposes of clarity, it is assumed that the bit value of a measurement basis value array Bx-y that corresponds to a particular aperture element 321 of an aperture 320 may be set to a first value (e.g., “0” or other suitable value) to indicate that the particular aperture element 321 is closed during the compressive measurement or may be set to a second value (e.g., “1” or other suitable value) to indicate that the particular aperture element 321 is open during the compressive measurement (i.e., it is assumed, for purposes of clarity, that intermediate values (e.g., which give partial, but not full, transmittance of light) are not supported). For example, the measurement basis information 322-1 for aperture 320-1 may include sets of measurement basis value arrays (e.g., a first measurement basis value array B1-1 [0, 1, 1, 0, 1, . . . ], a second measurement basis value array B1-1 [1, 1, 0, 0, 0, . . . ], and so forth, through measurement basis value array B1-m), the measurement basis information 322-2 for aperture 320-2 may include sets of measurement basis value arrays (e.g., a first measurement basis value array B2-1 [1, 1, 1, 1, 0, . . . ], a second measurement basis value array B2-1 [1, 0, 1, 0, 1, . . . ], and so forth, through measurement basis value array B2-m), the measurement basis information 322-3 for aperture 320-3 may include sets of measurement basis value arrays (e.g., a first measurement basis value array B3-1 [0, 0, 1, 1, 0, . . . ], a second measurement basis value array B3-1 [0, 0, 0, 1, 1, . . . ], and so forth, through measurement basis value array B3-m), and the measurement basis information 322-4 for aperture 320-4 may include sets of measurement basis value arrays (e.g., a first measurement basis value array B4-1 [1, 0, 1, 1, 0, . . . ], a second measurement basis value array B4-1 [1, 0, 0, 0, 1, . . . ], and so forth, through measurement basis value array B4-m). It will be appreciated that, in the exemplary block-based lensless camera 300, in which each of the apertures 320 includes an 8×8 array of aperture elements 321, each of the measurement basis value arrays Bx-y for a given aperture 320 will include sixty-four bit values (only some of which are given in the preceding examples) which correspond to the sixty-four aperture elements 321 of the given aperture 320. It will be appreciated that, in at least some embodiments, aperture elements 321 may be configured to controlled to be partially open/closed (e.g., using values between “0” and “1” or using other suitable values) such that, for a given aperture element 321, a portion of the light incident on the aperture element 321 is allowed to pass through the aperture element 321 and a portion of the light incident on the aperture element 321 is prevented from passing through the aperture element 321).

It will be appreciated that, if different aperture control patterns are used to control passage of light through the respective apertures 320-1-320-4, then different sets of measurement basis information 322-1-322-4 need to be used to control the respective aperture elements 321 of the apertures 320-1-320-4 (thereby requiring storage and use of different sets of measurement basis information 322-1-322-4 for the apertures 320-1-320-4 and, thus, increasing the storage requirements at the block-based lensless camera 300). It will be further appreciated that, if the same aperture control patterns are used to control each of the apertures 320-1-320-4, then the sets of measurement basis information 322-1-322-4 used to control the respective aperture elements 321 of the apertures 320-1-320-4 are the same and, thus, only a single set of measurement basis information 322-x is needed to control the respective aperture elements 321 of the apertures 320-1-320-4 (thereby requiring storage and use of only a single set of measurement basis information 322-x for the apertures 320-1-320-4 and, thus, significantly decreasing the storage requirements at the block-based lensless camera 300 while also reducing the image reconstruction time). It is noted that other intermediate arrangements (e.g., sharing of measurement basis information by some, but less than all, of the apertures 320 or other types of sharing) are contemplated.

The sensors 330 are each configured to detect light incident thereon and to generate sets of compressive measurements 332 based on detection of the light incident thereon. For example, as discussed above, each sensor 330 may include a photon detector configured to detect light incident on the sensor 330 and may include a compressive measurement device (e.g., an A/D converter or the like) configured to generate the sets of compressive measurements 332. More specifically, the sensor 330-1 generates a compressive measurement set 332-1 based on detection of light passing through aperture elements 321 of aperture 320-1 based on measurement basis information 322-1, the sensor 330-2 generates a compressive measurement set 332-2 based on detection of light passing through aperture elements 321 of aperture 320-2 based on measurement basis information 322-2, the sensor 330-3 generates a compressive measurement set 332-3 based on detection of light passing through aperture elements 321 of aperture 320-3 based on measurement basis information 322-3, and the sensor 330-4 generates a compressive measurement set 332-4 based on detection of light passing through aperture elements 321 of aperture 320-4 based on measurement basis information 322-4. In general, a given sensor 330-x is arranged to detect light passing through open (or at least partially open) aperture elements 321 of the associated aperture 320-x for each of the m measurement basis value arrays Bx-y of the associated aperture 320-x and to generate a set of m compressive measurements (denoted as Yx-1 through Yx-m) for the m measurement basis value arrays Bx-y of the associated aperture 320-x, respectively. For example, the sensor 330-1 is arranged to detect light passing through open aperture elements 321 of the associated aperture set 320-1 for each of the m measurement basis value arrays B1-y (namely, B1-1 through B1-m) of the measurement basis information 322-1 of the associated aperture 320-1 and to generate a set of m compressive measurements (denoted as Y1-1 through Y1-m) for the m measurement basis value arrays B1-y of the associated aperture 320-1, respectively. The sensors 330-2, 330-3, and 330-4 are similarly arranged to generate respective sets of m compressive measurements for the m measurement basis value arrays of the sets of measurement basis information 322-2, 322-3, and 322-4 for the associated apertures 320-2, 320-3, and 320-4, respectively.

It will be appreciated that the sets of m compressive measurements of the blocks of block-based lensless camera 300 represent the respective compressed image portions of the image captured by block-based lensless camera 300 (namely, the m compressive measurements of a block collectively represent the compressed image portion captured by the block) and, thus, together (where the collective set may be denoted as M compressive measurements), represent the compressed image captured by block-based lensless camera 300. It will be appreciated that, in compressive sense imaging, the number M of the compressive measurements that are acquired is typically significantly less than the N raw data values that are typically acquired in a conventional camera system having an N-pixel sensor for generating an N-pixel image, thus reducing or eliminating the need for further compression of the raw data values after acquisition. It is noted that, in at least some embodiments, the number of compressive measurements M (and, similarly, the number of per-block compressive measurements m) may be pre-selected relative to the number of aperture elements 321 based upon a pre-determined (e.g., desired or required) balance between compression level and image quality.

It will be appreciated that, although primarily presented with respect to specific numbers and arrangements of various elements of the block-based lensless camera 300 (e.g., four blocks, with each block having an aperture 320 including sixty-four aperture elements 321 and a sensor 330-x, respectively), the block-based lensless camera 300 may include various other numbers and/or arrangements of elements.

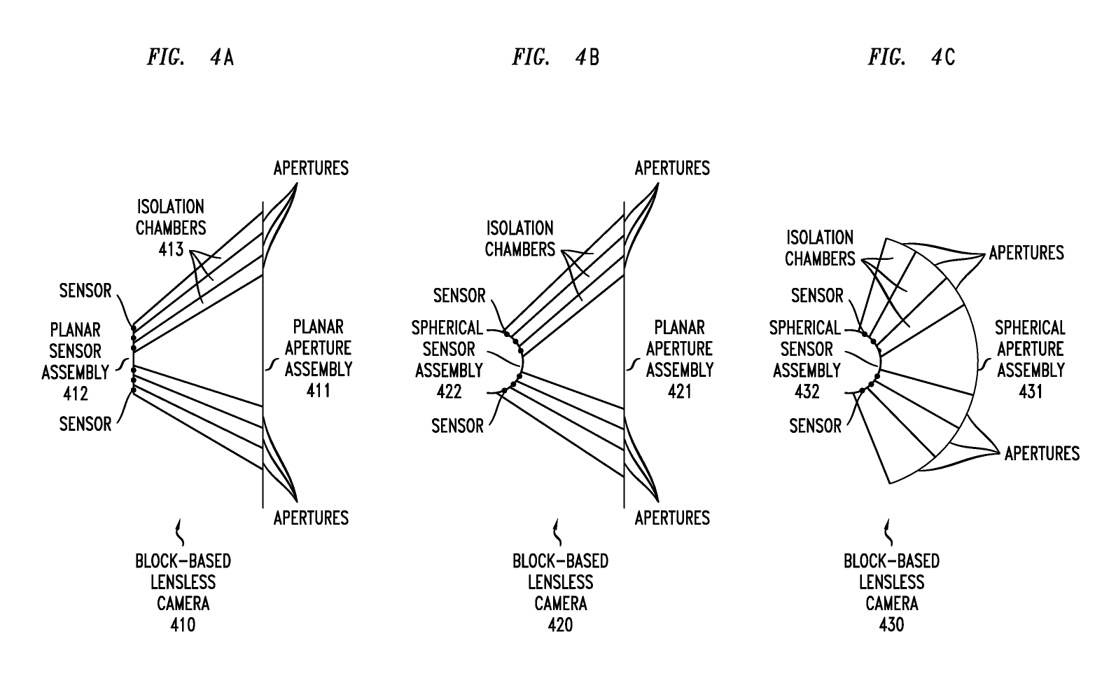

FIGS. 4A-4C depict exemplary cross-sectional views of aperture assemblies and sensor assemblies for a block-based lensless camera.

FIG. 4A depicts an exemplary cross-sectional view for a block-based lensless camera 410. The block-based lensless camera 410 has a planar aperture assembly 411 and a planar sensor assembly 412. The planar aperture assembly 411 includes a set of apertures arranged on a planar surface. The planar sensor assembly 412 includes a set of sensors arranged on a planar surface. The isolation chambers 413 are configured to isolate the light from the respective apertures of the planar aperture assembly 411 to be incident on the respective sensors of the planar sensor assembly 412 while preventing comingling of light with other isolation chambers 413 (and, thus, preventing comingling of light between blocks).

FIG. 4B depicts an exemplary cross-sectional view for a block-based lensless camera 420. The block-based lensless camera 420 has a planar aperture assembly 421 and a spherical sensor assembly 422. The planar aperture assembly 421 includes a set of apertures arranged on a planar surface. The spherical sensor assembly 422 includes a set of sensors arranged on a spherical surface (illustratively, on the outer surface of the sphere). The isolation chambers 423 are configured to isolate the light from the respective apertures of the planar aperture assembly 421 to be incident on the respective sensors of the spherical sensor assembly 422 while preventing comingling of light with other isolation chambers 423 (and, thus, preventing comingling of light between blocks). It is noted that the block-based lensless camera 420 may be configured to provide an increased angular resolution for far scenes (e.g., as compared with the block-based lensless camera 410 of FIG. 4A).

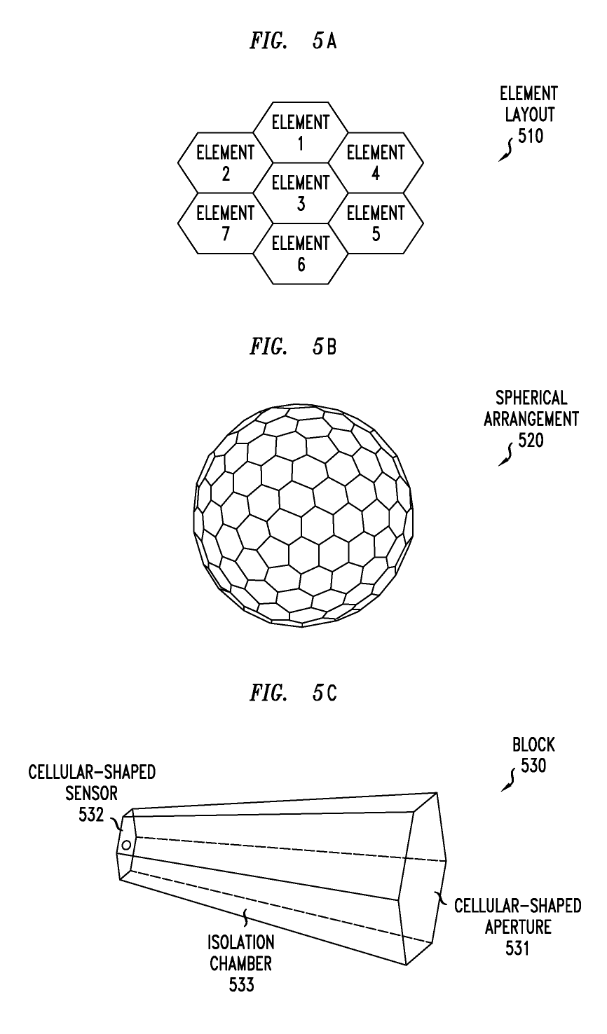

FIG. 4C depicts an exemplary cross-sectional view for a block-based lensless camera 430. The block-based lensless camera 430 has a spherical aperture assembly 431 and a spherical sensor assembly 432. The spherical aperture assembly 431 includes a set of apertures arranged on a spherical surface. The spherical sensor assembly 432 includes a set of sensors arranged on a spherical surface (illustratively, on the outer surface of the sphere). The isolation chambers 433 are configured to isolate the light from the respective apertures of the spherical aperture assembly 431 to be incident on the respective sensors of the spherical sensor assembly 432 while preventing comingling of light with other isolation chambers 433 (and, thus, preventing comingling of light between blocks). The block-based lensless camera 430 may be used as a wide-angle camera (which may be seen from the wide coverage area given by the lines of sight between the respective apertures of the spherical aperture assembly 431 and the respective sensors of the spherical sensor assembly 432. It is noted that the block-based lensless camera 430 may be configured to provide an increased angular resolution for far scenes (e.g., as compared with the block-based lensless camera 410 of FIG. 4A). In at least some embodiments, an exemplary embodiment of which is presented with respect to FIGS. 5A-5C, the block-based lensless camera 430 may be configured to use cellular-shaped apertures in the spherical aperture assembly 431 and cellular-shaped sensors in the spherical sensor assembly 432.

FIGS. 5A-5C depict an exemplary concentration-sensor configuration of a block-based lensless camera using cellular-shaped apertures and cellular-shaped sensors.

FIG. 5A depicts an exemplary layout 510 of the concentration-sensor regime for a block-based lensless camera using cellular-shaped apertures and sensors. The layout 510 illustrates the cellular arrangement of elements, where the elements may be apertures of an aperture assembly or sensors of a sensor assembly. The cellular shapes of the elements may be hexagonal or approximately hexagonal. It will be appreciated that, in the case in which the elements are the apertures of the block-based lensless camera, each element may include a respective set of aperture elements which, depending on the shape of the aperture elements (e.g., hexagonal, square, rectangular, or the like) and/or other factors, may or may not fill the entire element.

FIG. 5B depicts an exemplary spherical arrangement 520 of the concentration-sensor regime for a block-based lensless camera using cellular-shaped apertures and sensors. The spherical arrangement 520 may be used to provide a spherical arrangement of apertures of the aperture assembly, such as presented with respect to FIG. 4C. For example, where spherical arrangement 520 is used to provide a spherical arrangement of apertures of the aperture assembly, the spherical arrangement 520 may be implemented as a curved LCD or using other suitable spherical arrangements of cellular-shaped apertures. The spherical arrangement 520 may be used to provide a spherical arrangement of sensors of the sensor assembly, such as presented with respect to FIG. 4C. It will be appreciated that, in the case in which the hexagonal elements of the spherical arrangement 520 are the apertures of the block-based lensless camera, each hexagonal element may include a respective set of aperture elements which, depending on the shape of the aperture elements (e.g., hexagonal, square, rectangular, or the like) and/or other factors, may or may not fill the entire hexagonal element.

FIG. 5C depicts an exemplary block 530 of the concentration-sensor regime for a block-based lensless camera using cellular-shaped apertures and sensors. The block 530 has a cellular-shaped aperture 531, a cellular-shaped sensor 532, and a hexagonal “trumpet”-shaped isolation chamber 533. The “trumpet”-shaped cellular-shaped isolation chamber 533 is an elongated cellular-shaped chamber extending from the cellular-shaped aperture 531 toward the cellular-shaped sensor 532 while gradually getting smaller in the direction from the cellular-shaped aperture 531 toward the cellular-shaped sensor 532.

FIG. 6 depicts an exemplary block-based lensless compressive image acquisition system including an image reconstruction process for reconstructing an image captured by a block-based lensless camera.

As depicted in FIG. 6, block-based lensless compressive image acquisition system 600 of FIG. 6 is similar to the block-based lensless compressive image acquisition system 100 of FIG. 1. As depicted in FIG. 6, block-based lensless compressive image acquisition system 600 includes a block-based lensless camera 610, a memory 620, and a processor 630, which are similar to block-based lensless camera 110, memory 120, and processor 130, respectively, of the block-based lensless compressive image acquisition system 100 of FIG. 1. As further depicted in FIG. 6, the memory 620 is storing measurement basis information 622 and compressive measurements 624, which are similar to measurement basis information 122 and compressive measurements 124 stored in memory 120 of the block-based lensless compressive image acquisition system 100 of FIG. 1. Additionally, as further depicted in FIG. 6, the memory 620 also is storing an image reconstruction process 626 and an associated image 627 that is produced based on the image reconstruction process 626 (which were omitted from FIG. 1 for purposes of clarity).

The image reconstruction process 626 is configured to reconstruct the image 627 based on compressive measurements 624 captured by the block-based lensless camera 610. The image reconstruction process 626 is configured to reconstruct image portions associated with the blocks of the block-based lensless camera 610, respectively, and to reconstruct the image 627 by stitching together the image portions associated with the blocks of the block-based lensless camera 610.

The image reconstruction process 626, for each block of the block-based lensless camera 110, is configured to reconstruct an image portion captured by that block of the block-based lensless camera 110 based on the set of compressive measurements captured by that block of the block-based lensless camera 110.

The image reconstruction process 626, for a given block of the block-based lensless camera 610, may be configured to reconstruct an image portion captured by that block of the block-based lensless camera 610 by using a dictionary-based inversion and a Gaussian mixture model (GMM), a discussion of which follows.

In at least some embodiments in which the same patterns (same sets of measurement basis information) are used for each of the blocks, a compressive measurement may be considered as follows: Y=AX+N, where (1)×ε [symbol] ^{P×N}^{ₚ} with P denoting the dimension of the block (with size \sqrt{P}×\sqrt{P}) and N_{P} is the number of blocks used in the block-based lensless camera, (2) Aε [symbol] ^{M×P} with M<<P denoting the compressive measurements captured for each of the blocks, and (3) N signifying the additive noise. Here, Yε [symbol] ^{M×N}^{ₚ} is the measurement matrix with each column denoting the measurements corresponding to each of the blocks.

In at least some embodiments, in which the same patterns (same sets of measurement basis information) are used for each of the blocks, reconstruction of the image may be performed using a dictionary-based inversion. For example, by introducing a basis (or block-based) dictionary D, compressive measurement equation Y=AX+N can be reformulated as Y=ADS+N, where Dε [symbol] ^{P×Q} can be an orthonormal basis with Q=P or an over-complete dictionary. This dictionary may be pre-learned for fast inversion. It is noted that it may be desirable for Sε [symbol] ^{Q×N}^{ₚ} to be sparse so that various l₁ algorithms may be used to solve the following problem: min∥S∥₁, subject to Y=ADS given A and D. It is noted that various algorithms may be used to solve this problem. In at least some embodiments, as discussed further below, a GMM may be used to solve this problem, as a GMM generally does not require any iterations since closed-form analytic solutions exist.

In at least some embodiments, in which the same patterns (same sets of measurement basis information) are used for each of the blocks, reconstruction of the image may be performed using a dictionary-based inversion that is based on a GMM. The GMM has recently been re-recognized as an efficient dictionary learning algorithm. As indicated above, the image blocks that re extracted from the image may be denoted as Xε [symbol] ^{P×N}^{ₚ}. For the i-th patch xᵢ, it may be modeled as a GMM with K Gaussians as

$${x}_{i} ∼ {\sum }_{k = 1}^{K} {π}_{k} N ( {μ}_{k} , {Σ}_{k} )$$

where

$${\{ {μ}_{k} , {Σ}_{k} \}}_{k = 1}^{K}$$

represent me mean and covariance matrix of the k-th Gaussian and

$${\{ {π}_{k} \}}_{k = 1}^{K}$$

denotes the weights of these Gaussian components. Dropping the block index i, in a linear model

$$y = Ax + ɛ , ɛ ∈ N ( 0 , R ) , if x ∼ p ( x ) in {x}_{i} ∼ {\sum }_{k = 1}^{K} {π}_{k} N ( {μ}_{k} , {Σ}_{k} ) ,$$

then p(x|y) has the following analytical form

$$p ( x \vert y ) = {\sum }_{k = 1}^{K} {\tilde{π}}_{k} N ( {\tilde{μ}}_{k} , {\tilde{Σ}}_{k} )$$

where \tilde{π}ₖ=[πₖ(y|Axₖ, R⁻¹+AΣₖA^{T})]/[Σₗ₌₁^{K}πₗN(y|Axₗ,R⁻¹+AΣₗA^{T})], \tilde{Σ}ₖ=(A^{T}RA+Σₖ⁻¹), and \tilde{μ}ₖ=\tilde{Σ}ₖ(A^{T}Ry+Σₖ⁻¹μₖ). While \tilde{π}ₖ provides a posterior distribution for x, we obtain the point estimate of \tilde{x} via the posterior mean

$$E [ \hat{x} ] = {\sum }_{k = 1}^{K} {\tilde{π}}_{k} {\tilde{μ}}_{k} ,$$

which is a closed-form solution. It is noted that

$${\{ {π}_{k} {μ}_{k} , {Σ}_{k} \}}_{k = 1}^{K}$$

are pre-trained on other datasets and, given A, \tilde{Σ}ₖ only needs to be computed once and saved. The same techniques may be used for AΣₖA^{T}. Then, all that is left for each block is to calculate {\tilde{μ}ₖ,\tilde{π}ₖ}, which can be obtained very efficiently. It is noted that, using this GMM process, no iteration is required and, as a result, real-time reconstruction of blocks may be realized. Additionally, in at least some embodiments, each block may be reconstructed in parallel using one or more graphics processing units (GPUs).

The image reconstruction process 626 is configured to reconstruct the image 627 by stitching together the image portions reconstructed for the blocks of the block-based lensless camera 110, respectively. The stitching of the image portions may be performed using a real-time stitching algorithm, such that the image 627 may be obtained nearly instantly.

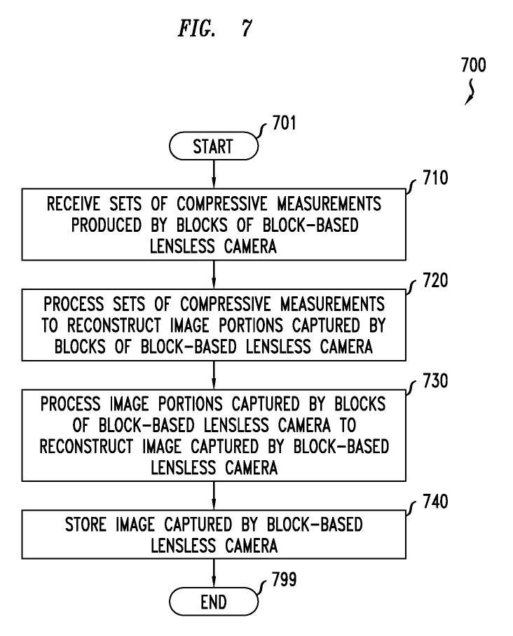

FIG. 7 depicts an exemplary embodiment of an image reconstruction process. The method 700 of FIG. 7 may be performed by a computing element which may be local to the block-based lensless camera (e.g., a processor of a block-based lensless compressive image acquisition system including the block-based lensless camera, such as by processor 630 of the block-based lensless compressive image acquisition system 600 of FIG. 6) or which may be remote from the block-based lensless camera (e.g., a remote computing element, such as where the compressive measurements captured by the block-based lensless camera may be transmitted by the block-based lensless camera to the remote computing element for processing). It will be appreciated that, although primarily presented as being performed serially, at least a portion of the functions of method 700 of FIG. 7 may be performed contemporaneously or in a different order than as presented in FIG. 7.

At step 701, method 700 begins.

At step 710, sets of compressive measurements are received. The sets of compressive measurements may be sets of compressive measurements produced by blocks of the block-based lensless camera or produced by one or more other devices based on detector output data produced by blocks of the block-based lensless camera. The sets of compressive measurements each include compressive measurements produced based on respective sets of measurement basis information used for controlling the light capture patterns of the aperture sets of the respective blocks of the block-based lensless camera (which, as discussed herein, may be the same or different for the respective blocks of the block-based lensless camera).

At step 720, the sets of compressive measurements associated with the respective blocks of the block-based lensless camera are processed to reconstruct respective image portions captured by the respective blocks of the block-based lensless camera. The sets of compressive measurements associated with the respective blocks of the block-based lensless camera may be processed, to reconstruct respective image portions captured by the respective blocks of the block-based lensless camera, as presented with respect to FIG. 6.

At step 730, the image portions reconstructed for the respective blocks of the block-based lensless camera are processed to reconstruct the image captured by the block-based lensless camera. The image portions reconstructed for the respective blocks of the block-based lensless camera are processed by stitching together the image portions to reconstruct the image captured by the block-based lensless camera. The image portions may be stitched together to reconstruct the image as presented with respect to FIG. 6.

At step 740, the image captured by the block-based lensless camera may be stored. The image also may be handled in other ways. For example, the image may be presented via a presentation interface associated with the block-based lensless camera (e.g., via a display of a tablet associated with the block-based lensless camera, via a display of a smartphone in which the block-based lensless camera is disposed, or the like). For example, the image may be transmitted via one or more communication paths (e.g., for storage and/or presentation at one or more remote devices). The image may be handled in various other ways in which images typically may be handled.

At step 799, method 700 ends.

It will be appreciated that, although primarily presented herein with respect to embodiments in which the sensors of the block-based lensless camera produce compressive measurements for compressive image acquisition, in at least some embodiments the compressive measurements for compressive image acquisition may be produced by one or more devices other than the sensors of the block-based lensless camera. For example, where the sensors of a block-based lensless camera include photon detectors, the detector output data from the sensors of the block-based lensless camera may be provided to one or more other devices (e.g., which may be disposed within the block-based lensless camera, external to but local to the block-based lensless camera, external to and remote from the block-based lensless camera, or the like, as well as various combinations thereof) configured to produce the compressive measurements based on the detector output data from the sensors of the block-based lensless camera (e.g., one or more devices such as one or more A/D converters, one or more processors configured to support A/D conversions functions, or the like, as well as various combinations thereof).

Various embodiments of the block-based lensless compressive image acquisition capabilities may provide various advantages. For example, since each block may be relatively small (e.g., 8×8, 16×16, or the like), only a relatively small number of compressive measurements (e.g., approximately 10 compressive measurements for an 8×8 block) are needed in order to achieve a relatively good reconstruction of the image and, thus, capture time may be quite short. For example, use of multiple equal-sized blocks may enable reuse of the same aperture pattern for each of the blocks such that the measurement basis for each of the blocks is also the same and, thus, is only of block size, thereby reducing the amount of memory needed to maintain the measurement basis information (reducing memory requirements) and enabling reductions in the image reconstruction time). For example, use of multiple blocks that produce compressive measurements for overlapping image portions enables parallel processing to produce the image portions as well as use of real-time image stitching algorithms for near-real-time or real-time image reconstruction. For example, use of multiple blocks weakens the diffraction effect since it will only come from limited pixels in each block. For example, the number of blocks that are used in the block-based lensless camera may be increased in order to increase image resolution while keeping the capture rate low and maintaining fast image reconstruction (since, again, the image capture by the respective blocks may be performed in parallel such that increasing the number of blocks does not (or at least not significantly) increase image reconstruction times). It is noted that various other potential advantages are contemplated.

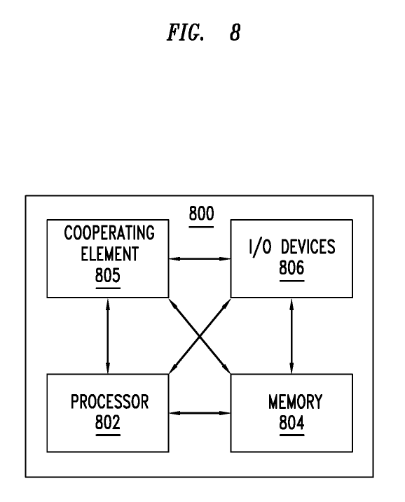

FIG. 8 depicts a high-level block diagram of a computer suitable for use in performing various functions presented herein.

The computer 800 includes a processor 802 (e.g., a central processing unit (CPU), a processor having a set of processor cores, a processor core of a processor, or the like) and a memory 804 (e.g., a random access memory (RAM), a read only memory (ROM), or the like). The processor 802 and the memory 804 are communicatively connected.

The computer 800 also may include a cooperating element 805. The cooperating element 805 may be a hardware device. The cooperating element 805 may be a process that can be loaded into the memory 804 and executed by the processor 802 to implement functions as discussed herein (in which case, for example, the cooperating element 805 (including associated data structures) can be stored on a non-transitory computer-readable storage medium, such as a storage device or other storage element (e.g., a magnetic drive, an optical drive, or the like)).

The computer 800 also may include one or more input/output devices 806. The input/output devices 806 may include one or more of a user input device (e.g., a keyboard, a keypad, a mouse, a microphone, a camera, or the like), a user output device (e.g., a display, a speaker, or the like), one or more network communication devices or elements (e.g., an input port, an output port, a receiver, a transmitter, a transceiver, or the like), one or more storage devices (e.g., a tape drive, a floppy drive, a hard disk drive, a compact disk drive, or the like), or the like, as well as various combinations thereof.

It will be appreciated that computer 800 of FIG. 8 may represent a general architecture and functionality suitable for implementing functional elements described herein, portions of functional elements described herein, or the like, as well as various combinations thereof. For example, computer 800 may provide a general architecture and functionality that is suitable for implementing all or part of one or more of block-based lensless compressive image acquisition system 100, block-based lensless compressive image acquisition system 600, or the like.

It will be appreciated that at least some of the functions depicted and described herein may be implemented in software (e.g., via implementation of software on one or more processors, for executing on a general purpose computer (e.g., via execution by one or more processors) so as to provide a special purpose computer, and the like) and/or may be implemented in hardware (e.g., using a general purpose computer, one or more application specific integrated circuits (ASIC), and/or any other hardware equivalents).

It will be appreciated that at least some of the functions discussed herein as software methods may be implemented within hardware, for example, as circuitry that cooperates with the processor to perform various functions. Portions of the functions/elements described herein may be implemented as a computer program product wherein computer instructions, when processed by a computer, adapt the operation of the computer such that the methods and/or techniques described herein are invoked or otherwise provided. Instructions for invoking the various methods may be stored in fixed or removable media (e.g., non-transitory computer-readable media), transmitted via a data stream in a broadcast or other signal bearing medium, and/or stored within a memory within a computing device operating according to the instructions.

It will be appreciated that the term “or” as used herein refers to a non-exclusive “or” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. A lensless compressive camera, comprising:
at least two image acquisition blocks, wherein each of the image acquisition blocks comprises:
an aperture including a set of aperture elements, each of the aperture elements configured to be controlled to permit or prevent passage of light therethrough;
a sensor configured to detect light passing through the aperture; and
an isolation chamber disposed between the aperture and the sensor, the isolation chamber configured to isolate the light passing through the aperture to be incident on the sensor and to prevent comingling of the light passing through the aperture with light of other image acquisition blocks.

2. The lensless compressive camera of claim 1, wherein, for each of the image acquisition blocks, the respective aperture is configured to modulate an amount of light permitted to pass therethrough and a pattern of light permitted to pass therethrough.

3. The lensless compressive camera of claim 1, wherein, for each of the image acquisition blocks, the aperture elements of the respective aperture are arranged as a two-dimensional array.

4. The lensless compressive camera of claim 1, wherein the aperture elements are configured to be individually controlled based on measurement basis information.

5. The lensless compressive camera of claim 1, wherein the aperture comprises a transparent liquid crystal display (LCD) device having programmable LCD elements or a transparent liquid crystal on silicon (LCoS) device having programmable LCoS elements.

6. The lensless compressive camera of claim 1, wherein the aperture is arranged on a planar surface, wherein the sensor is arranged on a planar surface or a spherical surface.

7. The lensless compressive camera of claim 1, wherein the aperture is arranged on a spherical surface, wherein the sensor is arranged on a spherical surface.

8. The lensless compressive camera of claim 1, wherein the sensor is arranged on planar surface, wherein the aperture is arranged on a planar surface.

9. The lensless compressive camera of claim 1, wherein the sensor is arranged on a spherical surface, wherein the aperture is arranged on a planar surface or a spherical surface.

10. The lensless compressive camera of claim 1, wherein, for each of the image acquisition blocks, the aperture of the respective image acquisition block has a cellular shape and the sensor of the respective image acquisition block has a cellular shape.

11. The lensless compressive camera of claim 1, wherein, for each of the image acquisition blocks, the isolation chamber of the respective image acquisition block has a trumpet-like shape.

12. The lensless compressive camera of claim 1, wherein the image acquisition blocks are configured to use a common set of measurement basis information to control respective sets of aperture elements of the respective apertures of the image acquisition blocks.

13. The lensless compressive camera of claim 1, wherein, for each of the image acquisition blocks, the respective sensor of the image acquisition block is configured to produce a respective compressive measurement based on detection of the light passing through the respective aperture.

14. The lensless compressive camera of claim 13, wherein, for each of the image acquisition blocks, the respective sensor comprises:
a photon detector configured to detect the light passing through the respective aperture and to produce a detector output based on detection of the light passing through the respective aperture; and
a device configured to produce the compressive measurement based on discretization of the detector output.

15. The lensless compressive camera of claim 1, wherein, for each of the image acquisition blocks, the respective sensor of the image acquisition block is configured to produce a set of compressive measurements based on a set of measurement basis information configured to control the respective aperture of the respective image acquisition block.

16. The lensless compressive camera of claim 1, wherein, for each of the image acquisition blocks, the respective sensor is configured to:
produce a respective detector output based on detection of the light passing through the respective aperture; and
send the detector output toward a device configured to produce the compressive measurement based on discretization of the detector output.

17. The lensless compressive camera of claim 16, wherein, for each of the image acquisition blocks, the respective sensor comprises a photon detector.

18. The lensless compressive camera of claim 1, wherein the lensless compressive camera is configured to be disposed within a tablet, a smartphone, or an Internet-of-Things device.

19. A lensless compressive image acquisition device, comprising:
a lensless compressive camera, the lensless compressive camera comprising at least two image acquisition blocks, wherein each of the image acquisition blocks comprises:
an aperture including a set of aperture elements, each of the aperture elements configured to be controlled to permit or prevent passage of light therethrough;
a sensor configured to detect light passing through the aperture; and
an isolation chamber disposed between the aperture and the sensor and configured to isolate the light passing through the aperture to be incident on the sensor and to prevent comingling of the light passing through the aperture with light of other image acquisition blocks;
a memory configured to store respective sets of compressive measurements associated with the respective image acquisition blocks; and
a processor configured to reconstruct an image based on processing of the respective sets of compressive measurements of the respective image acquisition blocks.

20. A lensless compressive camera, comprising:
an aperture assembly comprising a set of apertures, each of the apertures comprising a respective set of aperture elements configured to be controlled to permit or prevent passage of light therethrough;
a sensor assembly comprising a set of sensors, each of the sensors configured to detect light incident thereon; and
an isolation assembly disposed between the aperture assembly and the sensor assembly, the isolation assembly comprising a set of isolation chambers configured to isolate light passing through respective ones of the apertures of the aperture assembly to be incident on respective ones of the sensors of the sensor assembly and configured to prevent comingling of light between the isolation chambers.
